(19) United States
(12) Patent Application Publication
(10) Pub. No.: US 2026/0319615 A1
(43) Pub. Date: Oct. 15, 2026

(54) TOUCH STRUCTURE AND TOUCH DISPLAY PANEL

(71) Applicants: Chengdu BOE Optoelectronics Technology Co., Ltd., Chengdu, Sichuan (CN); BOE Technology Group Co., Ltd., Beijing (CN)

(72) Inventors: Ping LUO, Beijing (CN); Zhiqiang WANG, Beijing (CN); Guiyu ZHANG, Beijing (CN); Liqing JIANG, Beijing (CN); Lu RUAN, Beijing (CN); Jianjun LIU, Beijing (CN); Shuai LIU, Beijing (CN)

(21) Appl. No.: 19/482,495

(22) PCT Filed: Apr. 17, 2024
(86) PCT No.: PCT/CN2024/088261

§ 371 Date: Nov. 7, 2025

(30) Foreign Application Priority Data
May 31, 2023 (CN) 202310638498.3

(51) Int. Cl. G06F 3/041; G06F 3/044

(52) U.S. Cl. CPC G06F 3/04164; G06F 3/044; G06F 1/1618; G06F 2203/04102

(57) ABSTRACT

The present disclosure provides a touch structure and a touch display panel, wherein different first touch units are connected to the same touch detection module through different switch modules, and each touch detection module is configured to detect touch information of the plurality of first touch units connected to the touch detection module; and the processing control module is connected to the touch detection module and is respectively connected to all the plurality of switch modules, the processing control module is configured to determine folding and unfolding states of the touch display panel and respectively control opening and closing states of all the plurality of switch modules according to the folding and unfolding states, and the processing control module is configured to generate a touch driving signal and transmit the touch driving signal to the plurality of first touch units through the touch detection module.

### TECHNICAL FIELD

The present disclosure relates to the field of touch technology, in particular to a touch structure and a touch display panel.

### BACKGROUND

With the development of foldable display screens, folding modes of display screens are increasing, and for example, include triple-folding display screens, cross-folding display screens, inner-folding display screens in combination with auxiliary display screens. When a foldable display screen is in different folding states, touch driving modes are different.

An existing foldable display screen includes a plurality of touch units, a plurality of touch detection modules and a processing control module, wherein the number of the touch units is the same as that of the touch detection modules, the touch units are connected to the touch detection modules in one-to-one correspondence, the touch detection modules can detect touch information of the touch units connected to the touch detection modules, the processing control module is connected to all the touch detection modules and is used for receiving the touch information detected by all the touch detection modules, and integrating and processing all the touch information in different modes according to different folding states of the foldable display screen, so that different touch driving modes of the foldable display screen in different folding states are realized.

However, the number of touch detection modules used in the existing foldable display screen is relatively large, which results in high cost of the foldable display screen.

### SUMMARY

The present disclosure is directed to solve at least one of the technical problems in the prior art, and provides a touch structure and a touch display panel, which can reduce the number of touch detection modules, thereby reducing the cost. To achieve the above object, the present disclosure provides a touch structure, including a touch detection module, a plurality of first touch units, a plurality of switch modules, and a processing control module, wherein different first touch units are connected to the same touch detection module through different switch modules, the plurality of switch modules are capable of being opened and closed to control connection and disconnection between the plurality of first touch units and the touch detection module, and the touch detection module is configured to detect touch information of a corresponding first touch unit connected to the touch detection module; and
the processing control module is connected to the touch detection module and is respectively connected to all the plurality of switch modules, the processing control module is configured to determine folding and unfolding states of the touch display panel, and respectively control opening and closing states of all the plurality of switch modules according to the folding and unfolding states, and the processing control module is configured to generate a touch driving signal according to the folding and unfolding states and the touch information, and transmit the touch driving signal to the corresponding first touch unit through the touch detection module.

Optionally, the processing control module includes a processing module and a control module, the processing module is connected to all the touch detection modules and the control module, the processing module is configured to determine the folding and unfolding states, and transmit a control signal to the control module according to the folding and unfolding states, and the processing module is configured to generate the touch driving signal according to the folding and unfolding states and the touch information, and transmit the touch driving signal to the corresponding first touch unit through the touch detection module; and
the control module is respectively connected to all the plurality of switch modules, and is configured to respectively control the opening and closing states of all the plurality of switch modules according to the control signal.

Optionally, the touch structure further includes a plurality of touch lines, wherein the plurality of first touch units and the plurality of touch lines are in one-to-one correspondence with each other, the plurality of touch lines include first lines and second lines, the plurality of first touch units are connected to the plurality of switch modules through the first lines, and the plurality of switch modules are connected to the touch detection module through the second lines.

Optionally, the first lines corresponding to different first touch units are connected to different switch modules, and the second lines corresponding to the different first touch units are respectively connected to the same touch detection module.

Optionally, each first line includes a plurality of first sub-lines, each second line includes a plurality of second sub-lines, the plurality of first sub-lines and the plurality of second sub-lines are in one-to-one correspondence with each other, the first lines corresponding to different first touch units are connected to different switch modules, the second lines corresponding to different first touch units each have different numbers of second sub-lines, the second line with a larger number of second sub-lines is divided into a first line portion and a second line portion, the second sub-lines of the first line portion and the second sub-lines of another second line with a smaller number of second sub-lines are connected to each other in one-to-one correspondence to form a common line portion, and the second line portion and the common line portion are respectively connected to the same touch detection module.

Optionally, the touch structure further includes at least one second touch unit, wherein the at least one second touch unit and at least one first touch unit are selectively used as a one-piece touch unit, the number of the touch detection modules is the same as that of the at least one second touch unit, the touch detection modules are connected to the at least one second touch unit in one-to-one correspondence, and the first touch units are connected to, through different switch modules,, the different touch detection modules connected to the second touch units as the one-piece touch unit.

Optionally, each touch detection module is configured to detect a capacitance change generated by the second touch unit connected to the touch detection module due to the switching between the folding and unfolding states, the processing control module includes a processing module and a control module, the control module is connected to all the touch detection modules and all the plurality of switch modules, and the control module is configured to determine the folding and unfolding states according to the capacitance change, and control the opening and closing states of all the plurality of switch modules according to the folding and unfolding states; and
the processing module is connected to all the touch detection modules, and the processing module is configured to generate the touch driving signal according to the touch information and the folding and unfolding states, and transmit the touch driving signal to the corresponding first touch unit and the a corresponding second touch unit through the touch detection modules.

Optionally, the touch structure further includes a plurality of touch lines, wherein the plurality of first touch units and the plurality of touch lines are in one-to-one correspondence with each other, the plurality of touch lines include a plurality of first line groups and a plurality of second line groups in one-to-one correspondence with each other, the plurality of first touch units are connected to different switch modules through different first line groups, and different switch modules are connected to different touch detection modules through different second line groups.

Optionally, the touch structure further includes touch lines, the touch lines include an input line group and an output line group, the same first touch unit is connected to the same switch module through the input line group and the output line group, respectively; and the same switch module is connected to the same touch detection module through the input line group and the output line group, respectively.

The present disclosure further provides a touch display panel which includes a foldable display screen and the touch structure provided by the present disclosure.

The present disclosure has the following beneficial effects:

In the touch structure provided by the present disclosure, the different first touch units are connected to the same touch detection module through the different switch modules, and the processing control module may respectively control the opening and closing states of all the switch modules according to folding and unfolding states of the touch display panel, and therefore, when the folding and unfolding states of the touch display panel are changed, the opening and closing states of all the switch modules are respectively controlled by the processing control module, so that the connection and disconnection states between the different first touch units and the same touch detection module can be respectively changed, and thus when the touch display panel is in different folding and unfolding states, the processing control module may receive touch information from different first touch units, and then generate the touch driving signal according to the folding and unfolding states and the received touch information, transmit the touch driving signal to a corresponding first touch unit connected to the touch detection module through the touch detection module. That is, in the touch structure provided by the embodiment of the present disclosure, when the touch display panel is in different folding and unfolding states, different first touch units may be selected to be connected to the touch detection module, so that the touch driving signal may be transmitted to different first touch units through the same touch detection module, different touch driving modes can be realized, the number of the touch detection modules can be reduced, and the cost can be reduced.

According to the touch display panel provided by the present disclosure, the number of touch detection modules can be reduced by means of the touch structure provided by the present disclosure, so that the cost can be reduced.

### BRIEF DESCRIPTION OF DRAWINGS

FIG. 1 is a schematic diagram of a structure of a touch display panel and a touch structure of the touch display panel according to an embodiment of the present disclosure;

FIG. 2 is a schematic diagram of another structure of a touch structure of the touch display panel shown in FIG. 1;

FIG. 3 is a schematic diagram of a structure of a touch display panel according to an embodiment of the present disclosure;

FIG. 4 is a schematic diagram of a structure of the touch display panel and the touch structure of the touch display panel shown in FIG. 3; and

FIG. 5 is a schematic diagram of a partial enlarged structure of the touch display panel and the touch structure of the touch display panel shown in FIG. 4;

### DESCRIPTION OF THE REFERENCE NUMERALS

1—a touch detection module; 1a—a touch detection module; 1d—a touch detection module; 2—a first touch unit; 3—a switch module; 3ca—a switch module; 3cd—a switch module; 3ba—a switch module; 3bd—a switch module; 4—a processing control module; 41—a processing module; 42—a control module; 5—a second touch unit; 61—a first line; 62—a second line; 63—a first line portion; 64—a second line portion; 65—a common line portion; 66—a first line group; 67—a second line group; 68—an input line group; 69—an output line group; 71—a main display screen; 72—a secondary display screen; 73A—a display region; 73B—a display region; 73C—a display region; and 73D—a display region.

### DETAIL DESCRIPTION OF EMBODIMENTS

In order to enable one of ordinary skill in the art to better understand the technical solutions of the present disclosure, a touch structure and a touch display panel provided by the present disclosure will be described in further detail with reference to the accompanying drawings.

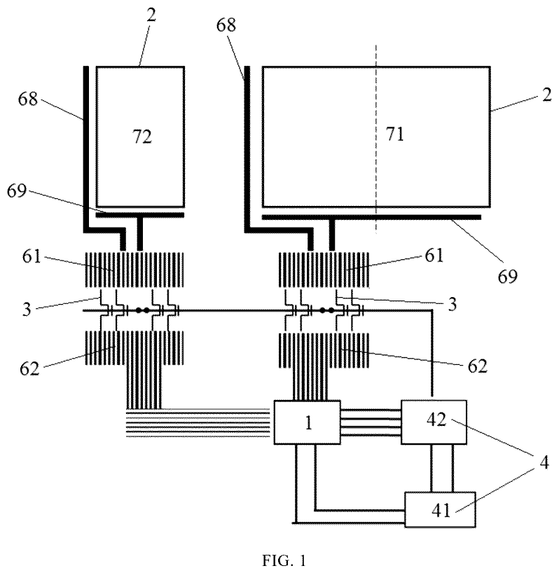

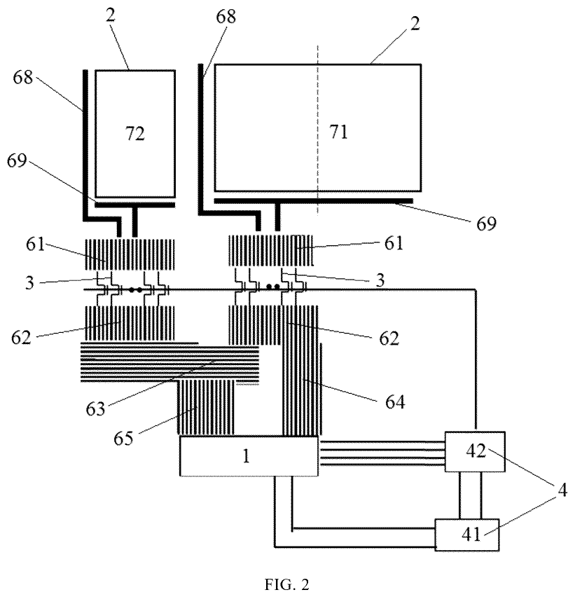

As shown in FIGS. 1 and 2, an embodiment of the present disclosure provides a touch structure, which includes a touch detection module 1, a plurality of first touch units 2, a plurality of switch modules 3, and a processing control module 4, where different first touch units 2 are connected to the same touch detection module 1 through different switch modules 3, the switch modules 3 may be opened and closed to control connection and disconnection between the first touch units 2 and the touch detection module 1, and the touch detection module 1 is configured to detect touch information of the first touch units 2 connected to the touch detection module 1; the processing control module 4 is connected to the touch detection module 1 and is respectively connected to all the switch modules 3, the processing control module 4 is configured to determine folding or unfolding states of the touch display panel and respectively control opening or closing states of all the switch modules 3 according to the folding or unfolding states, and the processing control module 4 is configured to generate a touch driving signal according to the touch information and the folding or unfolding states, and transmit the touch driving signal to the first touch units 2 through the touch detection module 1.

In the touch structure provided in the embodiment of the present disclosure, the different first touch units 2 are connected to the same touch detection module 1 through the different switch modules 3, and the processing control module 4 may respectively control the opening and closing states of all the switch modules 3 according to folding or unfolding states of the touch display panel, and therefore, when the folding or unfolding states of the touch display panel are changed, the opening and closing states of all the switch modules 3 are respectively controlled by the processing control module 4, so that the connection and disconnection states between the different first touch units 2 and the same touch detection module 1 can be respectively changed, and thus when the touch display panel is in different folding or unfolding states, the processing control module 4 may receive touch information from different first touch units 2, and then generate the touch driving signal according to the folding or unfolding states and the received touch information, transmit the touch driving signal to the first touch units 2 connected to the touch detection module 1 through the touch detection module 1. That is, when the touch display panel is in different folding and unfolding states, the touch structure provided by the embodiment of the present disclosure may select different first touch units 2 to be connected to the touch detection module 1, and send the touch driving signal to different first touch units 2 through the same touch detection module 1, so that different touch driving modes can be realized, the number of the touch detection modules 1 can be reduced, and the cost can be reduced.

For example, the touch display panel shown in FIGS. 1 and 2 may include a main display screen 71, a secondary display screen 72 and a touch structure, where the main display screen 71 is foldable, the secondary display screen 72 is not foldable, the touch structure may include one touch detection module 1, two first touch units 2, two switch modules 3 and one processing control module 4, the main display screen 71 may be correspondingly include one first touch unit 2, the secondary display screen 72 may be correspondingly include another first touch unit 2, the first touch unit 2 of the main display screen 71 may be connected to the one touch detection module 1 through one switch module 3, the touch unit of the secondary display screen 72 may be connected to the one touch detection module 1 through another switch module 3, that is, different first touch units 2 are connected to the same touch detection module 1 through different switch modules 3, the processing control module 4 is respectively connected to the two switch modules 3 and connected to the touch detection module 1.

In practical applications, the folding and unfolding states of the touch display panel shown in FIGS. 1 and 2 may include a folding state and an unfolding state, where the folding state may be a state in which the main display screen 71 is folded horizontally along a vertical folding dotted line shown in FIGS. 1 and 2, and the secondary display screen 72 is unfolded as shown in FIGS. 1 and 2. In the folding state, the main display screen 71 cannot achieve the touch function and the secondary display screen 72 may achieve the touch function. The unfolding state may be a state in which the main display screen 71 is in an unfolding state as shown in FIGS. 1 and 2 and the secondary display screen 72 is in an unfolding state as shown in FIGS. 1 and 2. In the unfolding state, the main display screen 71 may achieve the touch function, and the secondary display screen 72 cannot achieve the touch function, and the processing control module 4 may directly determine the folding and unfolding states of the touch display panel as shown in FIGS. 1 and 2.

When the touch display panel is in the folding state, the processing control module 4 may control the switch module 3 connected to the first touch unit 2 of the secondary display screen 72 to be in the closing state, and control the switch module 3 connected to the first touch unit 2 of the main display screen 71 to be in the opening state, so that the first touch unit 2 of the secondary display screen 72 is electrically connected to the touch detection module 1, and the first touch unit 2 of the main display screen 71 is electrically disconnected from the touch detection module 1, and therefore, the touch information of the first touch unit 2 of the secondary display screen 72 may be transmitted to the touch detection module 1 and detected by the touch detection module 1, and the touch information of the first touch unit 2 of the main display screen 71 cannot be transmitted to the touch detection module 1 and cannot be detected by the touch detection module 1, and the processing control module 4 may generate a touch signal according to the folding state and the touch information of the first touch unit 2 of the secondary display screen 72, and transmit the touch signal to the first touch unit 2 of the secondary display screen 72 through the touch detection module 1, as a result, the main display screen 71 cannot achieve the touch function and the secondary display screen 72 can achieve the touch function.

When the touch display panel is in the unfolding state, the processing control module 4 may control the switch module 3 connected to the first touch unit 2 of the secondary display screen 72 to be in the opening state, and control the switch module 3 connected to the first touch unit 2 of the main display screen 71 to be in the closing state, so that the first touch unit 2 of the secondary display screen 72 is electrically disconnected from the touch detection module 1, the first touch unit 2 of the main display screen 71 is electrically connected to the touch detection module 1, and therefore, the touch information of the first touch unit 2 of the secondary display screen 72 cannot be transmitted to the touch detection module 1 and cannot be detected by the touch detection module 1, and the touch information of the first touch unit 2 of the main display screen 71 may be transmitted to the touch detection module 1 and detected by the touch detection module 1, and the processing control module 4 may generate a touch signal according to the unfolding state and the touch information of the first touch unit 2 of the main display screen 71, and transmit the touch signal to the first touch unit 2 of the main display screen 71 through the touch detection module 1, as a result, the main display screen 71 may achieve the touch function, and the secondary display screen 72 cannot achieve the touch function.

Optionally, the touch detection module 1 may include a touch integrated circuit (TIC).

In practical applications, the touch integrated circuit may detect a capacitance of the first touch unit 2, the touch information may include capacitance information of the first touch unit 2 detected by the touch integrated circuit, and the capacitance of the first touch unit 2 corresponding to the display screen of the touch display panel may change when the display screen is touched, so that a touched position of the display screen corresponding to the first touch unit 2 may be determined according to the capacitance information of the first touch unit 2 detected by the touch integrated circuit.

As shown in FIGS. 1 and 2, in an embodiment of the present disclosure, the processing control module 4 may include a processing module 41 and a control module 42, the processing module 41 is connected to the touch detection module 1 and the control module 42, may determine the folding and unfolding states and transmit a control signal to the control module 42 according to the folding and unfolding states, and the processing module 41 may generate the touch driving signal according to the folding and unfolding states and the touch information and transmit the touch driving signal to the first touch unit 2 through the touch detection module 1; the control module 42 is respectively connected to all the switch modules 3, and the control module 42 may respectively control the opening and closing states of all the switch modules 3 according to the control signal.

In practical applications, the processing module 41 may directly determine the folding and unfolding states of the touch display panel shown in FIGS. 1 and 2, and transmit the control signal to the control module 42 according to the folding and unfolding states, the control module 42 may respectively control the opening and closing states of all the switch modules 3 according to the control signal, so as to respectively control the connection and disconnection states between different first touch units 2 and the same touch detection module 1, and the processing module 41 may generate the touch driving signal according to the folding and unfolding states and the touch information, detected by the touch detection module 1, of the first touch unit 2 connected to the touch detection module 1, and transmit the touch driving signal to the first touch unit 2 connected to the touch detection module 1 through the touch detection module 1.

Optionally, the processing module 41 may include a host.

Optionally, the control module 42 may include a source drive integrated circuit (SDIC).

As shown in FIGS. 1 and 2, in an embodiment of the present disclosure, the touch structure may further include a plurality of touch lines, the first touch units 2 and the touch lines are in one-to-one correspondence with each other, the touch lines may include first line 61 and second line 62, the first touch unit 2 may be connected to the switch module 3 through the first line 61, and the switch module 3 may be connected to the touch detection module 1 through the second line 62.

For example, as shown in FIGS. 1 and 2, the first touch unit 2 of the main display screen 71 of the touch display panel may correspond to one touch line, the first touch unit 2 of the secondary display screen 72 may correspond to another touch line, each touch line may include a first line 61 and a second line 62, one end of the first line 61 may be connected to the first touch unit 2, and the other end of the first line 61 may be connected to one end of the switch module 3, so that the connection of the first touch unit 2 and the switch module 3 through the first line 61 may be realized, that is, the first touch unit 2 may be connected to the switch module 3 through the first line 61. One end of the second line 62 may be connected to the other end of the switch module 3, and the other end of the second line 62 may be connected to the touch detection module 1, so that the connection of the switch module 3 and the touch detection module 1 through the second line 62 may be realized, that is, the switch module 3 may be connected to the touch detection module 1 through the second line 62.

In practical applications, when the switch module 3 is in the closing state, the touch signal of the first touch unit 2 may be transmitted to the touch detection module 1 through the first line 61, the switch module 3 and the second line 62 sequentially, and the touch signal generated by the processing control module 4 may be transmitted to the first touch unit 2 through the touch detection module 1, the second line 62, the switch module 3 and the first line 61 sequentially. When the switch module 3 is in the opening state, the touch signal of the first touch unit 2 cannot be transmitted to the second line 62 through the switch module 3, and thus cannot be transmitted to the touch detection module 1 and cannot be detected by the touch detection module 1, and the touch signal generated by the processing control module 4 cannot be transmitted to the first line 61 through the switch module 3, and thus cannot be transmitted to the first touch unit 2.

Optionally, the switch module 3 may include a thin film transistor (TFT).

As shown in FIG. 1, in an embodiment of the present disclosure, the first lines 61 corresponding to different first touch units 2 may be connected to different switch modules 3, and the second lines 62 corresponding to different first touch units 2 may be connected to the same touch detection module 1 respectively.

For example, the first line 61 corresponding to the first touch unit 2 of the main display screen 71 of the touch display panel shown in FIG. 1 may be connected to one switch module 3, and the first line 61 corresponding to the first touch unit 2 of the secondary display screen 72 may be connected to another switch module 3, that is, the first lines 61 corresponding to the different first touch units 2 may be connected to the different switch modules 3. The second line 62 corresponding to the first touch unit 2 of the main display screen 71 may be connected to the touch detection module 1, the second line 62 corresponding to the first touch unit 2 of the secondary display screen 72 may also be connected to the touch detection module 1, and the second line 62 corresponding to the first touch unit 2 of the main display screen 71 and the second line 62 corresponding to the first touch unit 2 of the secondary display screen 72 are separated from each other and are disconnected from each other, that is, the second lines 62 corresponding to different first touch units 2 may be connected to the same touch detection module 1 respectively.

As shown in FIG. 2, in an embodiment of the present disclosure, each first line 61 may include a plurality of first sub-lines, each second line 62 may include a plurality of second sub-lines, the first sub-lines and the second sub-lines are in one-to-one correspondence with each other, the first lines 61 corresponding to different first touch units 2 are connected to different switch modules 3, the second lines 62 corresponding to different first touch units 2 have different numbers of second sub-lines, the second line 62 with a larger number of second sub-lines is divided into a first line portion 63 and a second line portion 64, the second sub-lines of the first line portion 63 and the second sub-lines of another second line 62 with a smaller number of second sub-lines are connected to each other in one-to-one correspondence to form a common line portion 65, and the second line portion 64 and the common line portion 65 are respectively connected to the same touch detection module 1.

For example, as shown in FIGS. 1 and 2, the number of the second sub-lines of the second line 62 corresponding to the first touch unit 2 of the main display screen 71 of the touch display panel may be Xm, and the number of the second sub-lines of the second line 62 corresponding to the first touch unit 2 of the secondary display screen 72 may be Xn, where Xm is greater than Xn. In a case as shown in FIG. 1 where the second lines 62 corresponding to different first touch units 2 are connected to the same touch detection module 1, respectively, that is, the second sub-lines of the second line 62 corresponding to the first touch unit 2 of the main display screen 71 and the second sub-lines of the second line 62 corresponding to the first touch unit 2 of the secondary display screen 72 are respectively connected to the same touch detection module 1, the number of the second sub-lines connected to the same touch detection module 1 is Xm+Xn. In a case as shown in FIG. 2 where the second sub-lines of the second line 62 corresponding to the first touch unit 2 of the main display screen 71 may be divided into the first line portion 63 and the second line portion 64, the number of the second sub-lines of the first line portion 63 may be Xn, the number of the second sub-lines of the second line portion 64 may be Xm−Xn, the second sub-lines of the first line portion 63 may be connected to the second sub-lines of the second line 62 corresponding to the first touch unit 2 of the secondary display screen 72 in one-to-one correspondence to form the common line portion 65, the number of the second sub-lines of the common line portion 65 may be Xn, the second line portion 64 and the common line portion 65 are respectively connected to the same touch detection modules 1, so that the number of the second sub-lines connected to the same touch detection modules 1 is Xm−Xn+Xn=Xm. Compared with the case as shown in FIG. 1 that the second sub-lines 62 corresponding to different first touch units 2 are respectively connected to the same touch detection modules 1, in FIG. 2, the number of the second sub-lines connected to the same touch detection module 1 is reduced by Xn, which is equivalent to reducing the touch detection modules 1 connected to the second sub-lines of the second line 62 corresponding to the first touch unit 2 of the secondary display screen 72.

Therefore, the second line 62 with a large number of second sub-lines is divided into the first line portion 63 and the second line portion 64, the second sub-lines of the first line portion 63 and the second sub-lines of the second line 62 with a small number of second sub-lines are connected in one-to-one correspondence to form the common line portion 65, and the second line portion 64 and the common line portion 65 are connected to the same touch detection module 1, so that the number of the second sub-lines connected to the same touch detection module 1 can be reduced, and the cost of the touch detection module 1 can be reduced.

Optionally, the switch module 3 may include a plurality of switch members, and the first sub-lines, the switch members, and the second sub-lines may be connected in one-to-one correspondence.

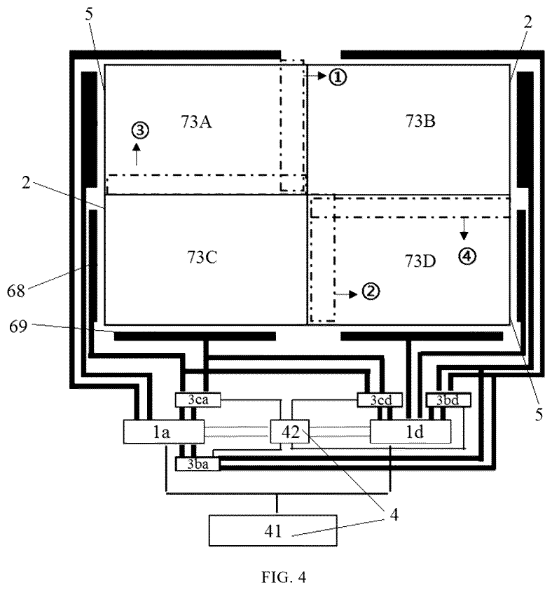

As shown in FIG. 4, in an embodiment of the present disclosure, the touch structure may further include at least one second touch unit 5, optionally, the second touch unit 5 and the at least one first touch unit 2 may be used as a one-piece touch unit, the number of the touch detection modules 1 is the same as that of the second touch units 5, the touch detection modules 1 are connected to the second touch units 5 in one-to-one correspondence, and the first touch units 2 are connected to the touch detection modules 1 connected to the different second touch units 5 as the one-piece touch unit through different switch modules 3.

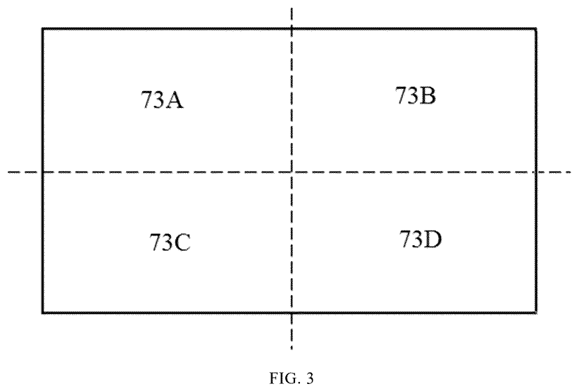

For example, the touch display panel shown in FIGS. 3 and 4 may include a display screen and a touch structure, where the display screen may be divided into four display regions to implement a cross-folding display screen, the four display regions are a display region 73A, a display region 73B, a display region 73C, and a display region 73D respectively, the touch structure may include two touch detection modules 1, two first touch units 2, two second touch units 5, four switch modules 3, and one processing control module 4. The display region 73A may be correspondingly provided with one second touch unit 5, the display region 73B may be correspondingly provided with one first touch unit 2, the display region 73C may be correspondingly provided with one first touch unit 2, and the display region 73D may be correspondingly provided with one second touch unit 5. The main display screen 71 may be in the unfolding state as shown in FIGS. 3 and 4, specifically, may be folded horizontally as shown by the vertical folding dotted line in FIG. 3 to present a horizontally folding state, or may be folded vertically as shown by the horizontal folding dotted line in FIG. 3 to present a vertically folding state, thereby implementing the cross-folding.

In the unfolding state, the display region 73A, the display region 73B, the display region 73C and the display region 73D form a one-piece display region, the display screen is a full-screen touch display, and the second touch unit 5 in the display region 73A, the first touch unit 2 in the display region 73B, the first touch unit 2 in the display region 73C and the second touch unit 5 in the display region 73D form a one-piece touch unit. In the horizontally folding state, the display region 73A and the display region 73C form a one-piece display region, the display region 73B and the display region 73D form another one-piece display region, the display screen is horizontally divided into two independent half-screen touch display portions, the second touch unit 5 of the display region 73A and the first touch unit 2 of the display region 73C form a one-piece touch unit, and the first touch unit 2 of the display region 73B and the second touch unit 5 of the display region 73D form another one-piece touch unit. In the vertically folding state, the display region 73A and the display region 73B form a one-piece display region, the display region 73C and the display region 73D form another one-piece display region, the display screen is vertically divided into two independent half-screen touch display portions, the second touch unit 5 of the display region 73A and the first touch unit 2 of the display region 73B form a one-piece touch unit, and the first touch unit 2 of the display region 73C and the second touch unit 5 of the display region 73D form another one-piece touch unit.

The second touch unit 5 of the display region 73A is directly connected to one touch detection module 1, and the second touch unit 5 of the display region 73D is directly connected to another touch detection module 1, that is, the touch detection modules 1 are connected to the second touch units 5 in one-to-one correspondence. The first touch unit 2 of the display region 73B is connected to, through one switch module 3 (i.e., a switch module 3ba in FIG. 4), one touch detection module 1 (i.e., a touch detection module 1a in FIG. 4) connected to the second touch unit 5 of the display region 73A and is connected to, through another switch module 3 (i.e., a switch module 3bd in FIG. 4), another touch detection module 1 (i.e., a touch detection module 1d in FIG. 4) connected to the second touch unit 5 of the display region 73D. The first touch unit 2 of the display region 73C is connected to, through one switch module 3 (i.e., a switch module 3ca in FIG. 4), one touch detection module 1 (i.e., a touch detection module 1a in FIG. 4) connected to the second touch unit 5 of the display region 73A, and is connected to, through another switch module 3 (i.e., a switch module 3cd in FIG. 4), another touch detection module 1 (i.e., a touch detection module 1d in FIG. 4) connected to the second touch unit 5 of the display region 73D. That is, the first touch units 2 are connected to the different touch detection modules 1 connected to the second touch units 5 as a one-piece touch unit, through the different switch modules 3. The processing control module 4 is respectively connected to the four switch modules 3 and the two touch detection modules 1.

When the touch display panel is in the unfolding state, the processing control module 4 may control the switch module 3ba to be closed such that the first touch unit 2 of the display region 73B is connected to the touch detection module 1a, control the switch module 3bd to be opened such that the first touch unit 2 of the display region 73B is disconnected from the touch detection module 1d, control the switch module 3ca to be opened such that the first touch unit 2 of the display region 73C is disconnected from the touch detection module 1a, and control the switch module 3cd to be closed such that the first touch unit 2 of the display region 73C is connected to the touch detection module 1d. In this way, both the touch information of the second touch unit 5 of the display region 73A and the touch information of the first touch unit 2 of the display region 73B may be transmitted to the touch detection module 1a and be detected by the touch detection module 1a, and the touch information of the first touch unit 2 of the display region 73C and the touch information of the second touch unit 5 of the display region 73D may be transmitted to the touch detection module 1d and be detected by the touch detection module 1d. Then, the processing control module 4 may generate a full-screen touch signal according to the unfolding state, the touch information of the display region 73A, the touch information of the display region 73B, the touch information of the display region 73C, and the touch information of the display region 73D, and transmit the full-screen touch signal to the second touch unit 5 of the display region 73A and the first touch unit 2 of the display region 73B through the touch detection module 1a, and transmit the full-screen touch signal to the second touch unit 5 of the display region 73D and the first touch unit 2 of the display region 73C through the touch detection module 1d, thereby realizing the full-screen touch display of the display screen.

When the touch display panel is in the vertically folding state, the processing control module 4 may control the switch module 3ba to be closed such that the first touch unit 2 of the display region 73B is connected to the touch detection module 1a, control the switch module 3bd to be opened such that the first touch unit 2 of the display region 73B is disconnected from the touch detection module 1d, control the switch module 3ca to be opened such that the first touch unit 2 of the display region 73C is disconnected from the touch detection module 1a, control the switch module 3cd to be closed such that the first touch unit 2 of the display region 73C is connected to the touch detection module 1d. In this way, both the touch information of the second touch unit 5 of the display region 73A and the touch information of the first touch unit 2 of the display region 73B may be transmitted to the touch detection module 1a and be detected by the touch detection module 1a, and the touch information of the first touch unit 2 of the display region 73C and the touch information of the second touch unit 5 of the display region 73D may be transmitted to the touch detection module 1d and be detected by the touch detection module 1d. Then, the processing control module 4 may generate a half-screen touch signal according to the vertically folding state, the touch information of the display region 73A, the touch information of the display region 73B, the touch information of the display region 73C and the touch information of the display region 73D, and transmit the half-screen touch signal to the second touch unit 5 of the display region 73A and the first touch unit 2 of the display region 73B through the touch detection module 1a, and transmit the half-screen touch signal to the second touch unit 5 of the display region 73D and the first touch unit 2 of the display region 73C through the touch detection module 1d, thereby realizing that the display screen is horizontally divided into two independent half-screen touch display portions.

When the touch display panel is in the horizontally folding state, the processing control module 4 may control the switch module 3ba to be opened such that the first touch unit 2 of the display region 73B is disconnected from the touch detection module 1a, control the switch module 3bd to be closed such that the first touch unit 2 of the display region 73B is connected to the touch detection module 1d, control the switch module 3ca to be closed such that the first touch unit 2 of the display region 73C is connected to the touch detection module 1a, and control the switch module 3cd to be opened such that the first touch unit 2 of the display region 73C is disconnected from the touch detection module 1d. In this way, both the touch information of the second touch unit 5 of the display region 73A and the touch information of the first touch unit 2 of the display region 73C may be transmitted to the touch detection module 1a and be detected by the touch detection module 1a, and the touch information of the first touch unit 2 of the display region 73B and the touch information of the second touch unit 5 of the display region 73D may be transmitted to the touch detection module 1d and detected by the touch detection module 1d. Then, the processing control module 4 may generate a half-screen touch signal according to the horizontally folding state, the touch information of the display region 73A, the touch information of the display region 73B, the touch information of the display region 73C and the touch information of the display region 73D, and transmit the half-screen touch signal to the second touch unit 5 of the display region 73A and the first touch unit 2 of the display region 73C through the touch detection module 1a, and transmit the half-screen touch signal to the second touch unit 5 of the display region 73D and the first touch unit 2 of the display region 73B through the touch detection module 1d, thereby realizing that the display screen is vertically divided into two independent half-screen touch display portions.

As shown in FIG. 4, in an embodiment of the present disclosure, the touch detection module 1 may detect a capacitance change generated by the second touch unit 5 connected to the touch detection module 1 due to the switching between the folding and unfolding states. The processing control module 4 may include the processing module 41 and the control module 42. The control module 42 is connected to all the touch detection modules 1 and all the switch modules 3, and the control module 42 may determine the folding and unfolding states according to the capacitance change, and control the opening and closing states of all the switch modules 3 according to the folding and unfolding states; the processing module 41 is connected to all the touch detection modules 1, and the processing module 41 may generate a touch driving signal according to the touch information and the folding and unfolding states, and transmit the touch driving signal to the first touch unit 2 and the second touch unit 5 through the touch detection modules 1.

For example, in the touch display panel shown in FIG. 4, the touch detection module la may detect the capacitance change as shown in a dashed box 1 in FIG. 4 (that is, the capacitance change generated by the second touch unit 5 of the display region 73A due to the horizontally folding of the touch display panel) and the capacitance change as shown in a dashed box \textcircled{3} in FIG. 4 (that is, the capacitance change generated by the second touch unit 5 of the display region 73A due to the vertically folding of the touch display panel). The touch detection module 1d may detect the capacitance change as shown in a dashed box \textcircled{2} in FIG. 4 (that is, the capacitance change generated by the second touch unit 5 of the display region 73D due to the horizontally folding of the touch display panel) and the capacitance change as shown in a dashed box 4 in FIG. 4 (that is, the capacitance change generated by the second touch unit 5 of the display region 73D due to the vertically folding of the touch display panel).

In practical applications, the switch module 3cd and the switch module 3ba may be normally closed, and the switch module 3ca and the switch module 3bd may be normally opened. When the touch detection module 1a detects the capacitance change as shown in the dashed box \textcircled{1} in FIG. 4 and the capacitance change as shown in the dashed box \textcircled{2} in FIG. 4, and a preset capacitance is less than an overall capacitance change, (that is, the capacitance change in the dashed box \textcircled{1}+the capacitance change in the dashed box \textcircled{2}<a touch capacitance, based on this, the control module 42 may determine that the touch display panel is horizontally folded. Therefore, the switch module 3ba may be controlled to be opened, the switch module 3bd may be controlled to be closed, the switch module 3ca may be controlled to be closed, and the switch module 3cd may be controlled to be opened. The processing module 41 may independently drive the two half screens in a horizontal direction according to the horizontally folding state. When the touch detection module 1a detects the capacitance change as shown in the dashed box \textcircled{3} in FIG. 4 and the capacitance change as shown in the dashed box \textcircled{4} in FIG. 4, and a preset capacitance is less than an overall capacitance change, (that is, the capacitance change in the dashed box \textcircled{3}+the capacitance change in the dashed box \textcircled{4} a touch capacitance, based on this, the control module 42 may determine that the touch display panel is vertically folded. Therefore, the switch module 3ba may be controlled to be closed, the switch module 3bd may be controlled to be opened, the switch module 3ca may be controlled to be opened, and the switch module 3cd may be controlled to be closed. The processing module 41 may independently drive the two half screens in a vertical direction according to the horizontally folding state. When neither the touch detection module 1a nor the touch detection module 1d detects the capacitance change, or when the control module 42 does not determine that the display panel is folded according to the capacitance change detected by the touch detection module 1a and the touch detection module 1d, it indicates that the touch display panel is in the unfolding state. The switch module 3cd and the switch module 3ba may be kept closed, and the switch module 3ca and the switch module 3bd may be kept opened. The processing module 41 may perform the full screen driving based on the unfolding state.

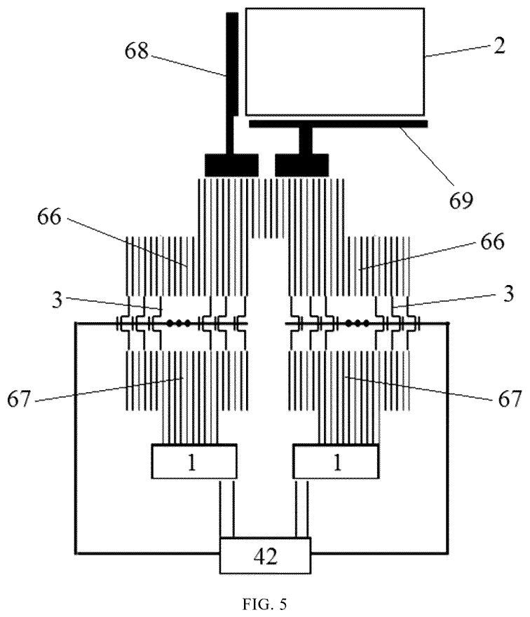

As shown in FIG. 5, in an embodiment of the present disclosure, the touch structure may further include a plurality of touch lines, the first touch units 2 and the touch lines are in one-to-one correspondence with each other, the touch lines include a plurality of first line groups 66 and a plurality of second line groups 67 in one-to-one correspondence with each other, the first touch units 2 are connected to different switch modules 3 through different first line groups 66, and different switch modules 3 are connected to different touch detection modules 1 through different second line groups 67.

For example, as shown in FIG. 5, a first touch unit 2 of one display region 73 of the touch display panel corresponds to one touch line, the touch line includes two first line groups 66 and two second line groups 67, the first touch unit 2 is connected to one switch module 3 through one first line group 66 and is connected to another switch module 3 through another first line group 66, that is, the first touch unit 2 is connected to the different switch modules 3 through the different first line groups 66. One switch module 3 is connected to one touch detection module 1 through one second line group 67 and is connected to another touch detection module 1 through another second line group 67, that is, the different switch modules 3 are connected to the different touch detection modules 1 through the different second line groups 67.

As shown in FIG. 4, in an embodiment of the present disclosure, the touch structure may further include touch lines, where the touch lines may include an input line group 68 and an output line group 69, the same first touch unit 2 is connected to the same switch module 3 through the input line group 68 and the output line group 69, respectively, and the same switch module 3 is connected to the same touch detection module 1 through the input line group 68 and the output line group 69, respectively.

For example, in the touch detection panel as shown FIG. 4, the first touch unit 2 of the display region 73C may be connected to the switch module 3ca through the input line group 68 and the output line group 69, respectively, and connected to the switch module 3cd through the input line group 68 and the output line group 69, respectively, the switch module 3ca is connected to the touch detection module 1a through the input line group 68 and the output line group 69, respectively, and the switch module 3cd is connected to the touch detection module 1d through the input line group 68 and the output line group 69, respectively.

As shown in FIG. 4, optionally, the second touch unit 5 is connected to the corresponding touch detection module 1 through the input line group 68 and the output line group 69, respectively.

The embodiment of the present disclosure further provides a touch display panel, which includes a foldable display screen and the touch structure provided by the embodiment of the present disclosure.

According to the touch display panel provided by the embodiment of the present disclosure, in the touch structure provided by the present disclosure, the number of touch detection modules 1 can be reduced, so that the cost can be reduced.

In summary, the touch structure and the touch display panel provided in the embodiments of the present disclosure can reduce the number of the touch detection modules 1, so as to reduce the cost.

It should be understood that the above embodiments are merely exemplary embodiments adopted to explain the principles of the present disclosure, and the present disclosure is not limited thereto. It will be apparent to one of ordinary skill in the art that various changes and modifications may be made therein without departing from the spirit and essence of the present disclosure, and such changes and modifications also fall within the scope of the present disclosure.

1. A touch structure, comprising a touch detection module, a plurality of first touch units, a plurality of switch modules, and a processing control module, wherein different first touch units are connected to the same touch detection module through different switch modules, the plurality of switch modules are capable of being opened and closed to control connection and disconnection between the plurality of first touch units and the touch detection module, and the touch detection module is configured to detect touch information of a corresponding first touch unit connected to the touch detection module; and
the processing control module is connected to the touch detection module and is respectively connected to all the plurality of switch modules, the processing control module is configured to determine folding and unfolding states of the touch display panel, and respectively control opening and closing states of all the plurality of switch modules according to the folding and unfolding states, and the processing control module is configured to generate a touch driving signal according to the folding and unfolding states and the touch information, and transmit the touch driving signal to the corresponding first touch unit through the touch detection module.

2. The touch structure of claim 1, wherein the processing control module comprises a processing module and a control module, the processing module is connected to all the touch detection modules and the control module, the processing module is configured to determine the folding and unfolding states, and transmit a control signal to the control module according to the folding and unfolding states, and the processing module is configured to generate the touch driving signal according to the folding and unfolding states and the touch information, and transmit the touch driving signal to the corresponding first touch unit through the touch detection module; and
the control module is respectively connected to all the plurality of switch modules, and is configured to respectively control the opening and closing states of all the plurality of switch modules according to the control signal.

3. The touch structure of claim 1, further comprising a plurality of touch lines, wherein the plurality of first touch units and the plurality of touch lines are in one-to-one correspondence with each other, the plurality of touch lines comprise first lines and second lines, the plurality of first touch units are connected to the plurality of switch modules through the first lines, and the plurality of switch modules are connected to the touch detection module through the second lines.

4. The touch structure of claim 3, wherein the first lines corresponding to different first touch units are connected to different switch modules, and the second lines corresponding to the different first touch units are respectively connected to the same touch detection module.

5. The touch structure of claim 3, wherein each first line comprises a plurality of first sub-lines, each second line comprises a plurality of second sub-lines, the plurality of first sub-lines and the plurality of second sub-lines are in one-to-one correspondence with each other, the first lines corresponding to different first touch units are connected to different switch modules, the second lines corresponding to different first touch units each have different numbers of second sub-lines, the second line with a larger number of second sub-lines is divided into a first line portion and a second line portion, the second sub-lines of the first line portion and the second sub-lines of another second line with a smaller number of second sub-lines are connected to each other in one-to-one correspondence to form a common line portion, and the second line portion and the common line portion are respectively connected to the same touch detection module.

6. The touch structure of claim 1, further comprising at least one second touch unit, wherein the at least one second touch unit and at least one first touch unit are selectively used as a one-piece touch unit, the number of the touch detection modules is the same as the number of the at least one second touch unit, the touch detection modules are connected to the at least one second touch unit in one-to-one correspondence, and the first touch units are connected to, through different switch modules, the different touch detection modules connected to the second touch units as the one-piece touch unit.

7. The touch structure of claim 6, wherein each touch detection module is configured to detect a capacitance change generated by the second touch unit connected to the touch detection module due to the switching between the folding and unfolding states, the processing control module comprises a processing module and a control module, the control module is connected to all the touch detection modules and all the plurality of switch modules, and the control module is configured to determine the folding and unfolding states according to the capacitance change, and control the opening and closing states of all the plurality of switch modules according to the folding and unfolding states; and
the processing module is connected to all the touch detection modules, and the processing module is configured to generate the touch driving signal according to the touch information and the folding and unfolding states, and transmit the touch driving signal to corresponding first touch unit and a corresponding second touch unit through the touch detection modules.

8. The touch structure of claim 6, further comprising a plurality of touch lines, wherein the plurality of first touch units and the plurality of touch lines are in one-to-one correspondence with each other, the plurality of touch lines comprise a plurality of first line groups and a plurality of second line groups in one-to-one correspondence with each other, the plurality of first touch units are connected to different switch modules through different first line groups, and different switch modules are connected to different touch detection modules through different second line groups.

9. The touch structure of claim 1, wherein the touch structure further comprises touch lines, the touch lines comprise an input line group and an output line group, the same first touch unit is connected to the same switch module through the input line group and the output line group, respectively; and the same switch module is connected to the same touch detection module through the input line group and the output line group, respectively.

10. A touch display panel, comprising a foldable display screen and the touch structure of claim 1.

11. The touch structure of claim 2, wherein the touch structure further comprises touch lines, the touch lines comprise an input line group and an output line group, the same first touch unit is connected to the same switch module through the input line group and the output line group, respectively; and the same switch module is connected to the same touch detection module through the input line group and the output line group, respectively.
